(19) United States
(12) Patent Application Publication
(10) Pub. No.: US 2018/0370384 A1
(43) Pub. Date: Dec. 27, 2018

(54) MOUNTING STRUCTURE FOR HIGH-VOLTAGE CONTROL EQUIPMENT UNIT

(71) Applicant: HONDA MOTOR CO., LTD., Tokyo (JP)

(72) Inventors: Tomoatsu Murakami, Wako-shi (JP); Hidetomo Fujiwara, Wako-shi (JP)

(73) Assignee: HONDA MOTOR CO., LTD., Tokyo (JP)

(21) Appl. No.: 16/061,823

(22) PCT Filed: Aug. 24, 2016
(86) PCT No.: PCT/JP2016/074610

§ 371 Date: Jun. 13, 2018

(30) Foreign Application Priority Data
Dec. 22, 2015 (JP) PCT/JP2015/085895

(51) Int. Cl. B60L 11/18; B60K 1/04

(52) U.S. Cl. CPC B60L 11/1877; B60K 6/405; B60L 11/1864; B60K 1/04

(57) ABSTRACT

To achieve effective use of space in a vehicle compartment by optimizing arrangement of a high-voltage control equipment unit including batteries. The high-voltage control equipment unit (20) includes two batteries (50-1, 50-2) juxtaposed in the width direction of the vehicle (1), a high-voltage electrical component (56) for controlling power delivery from the batteries (50-1, 50-2), and a case (30) integrally housing the batteries (50-1, 50-2) and the high-voltage electrical component (56). The two batteries (50-1, 50-2) are mounted under front seats (5-1, 5-2). The high-voltage electrical component (56) is mounted between the two front seats (5-1, 5-2) in the vehicle width direction. On a bottom surface (33) of the case (30), a recessed portion (32) in which a propeller shaft (4) extending in the longitudinal direction of the vehicle (1) is formed.

### TECHNICAL FIELD

The present invention relates to a mounting structure for a high-voltage control equipment unit mounted above a floor panel of a vehicle having a battery for driving the vehicle.

### BACKGROUND ART

On an automobile that runs using a motor together with an engine (hereinafter referred to as “hybrid electric vehicle (HEV)”) or an automobile that runs only using a motor (hereinafter referred to as “electric car”), a battery (battery module) for storing electricity and supplying the electricity to an electric machinery apparatus is mounted. As a part of the high-voltage control equipment unit, the battery is often housed in a case (battery case), together with high-voltage electrical components including an inverter device.

An available temperature environment for the above-mentioned battery is limited in order to exhibit its enough performance. Therefore, when the battery is arranged in a vehicle compartment, it is desirable to arrange the battery at a lower position (downward) at a relatively low temperature in the vehicle compartment, avoiding a higher position at a high temperature under sunlight. In addition, it is necessary to arrange the battery at a place under a seat that is a dead space in the vehicle compartment to secure enough space for occupants. Patent Documents 1 and 2 disclose a structure in which a battery is arranged under a seat in a vehicle compartment.

In a four-wheel drive (4WD) vehicle, a propeller shaft (driving force transmitting member) extending in the longitudinal direction of the vehicle at a center of the vehicle in the lateral direction is arranged under a floor panel of the vehicle. In addition, even in a front-wheel (two-wheel) drive (2WD) vehicle, an exhaust pipe in which exhaust air from an engine (drive source) circulates and a wiring component for supplying electric power to auxiliary machinery mounted on the vehicle (for example, various electric lights and air-conditioners and related parts thereof) may be disposed under the floor panel. Accordingly, in the case of the conventional structure, when the above-mentioned voltage control equipment unit is installed, the high-voltage control equipment unit is mounted above (or, at a position right above) the propeller shaft, the exhaust pipe or the wiring component for the auxiliary machinery. As this requires the mounting position of the whole or part of the high-voltage control equipment unit to be high, it is necessary to arrange part of the high-voltage control equipment unit to a component such as a center console arranged between front seats. Thus, components of the high-voltage control equipment unit are installed, so as to be projected into the vehicle compartment, for example, at a position where the components are sandwiched between left and right front seats. This causes difficulty in effective use of space in the vehicle compartment. Furthermore, in an attempt to arrange the high-voltage control equipment unit under the seat in the vehicle compartment, the seat is installed necessarily at a higher position, preventing the vehicle floor from being lowered.

Moreover, it is necessary to arrange the battery housed in a case, power distribution components such as a junction box, a main switch (starter) of the battery, high-voltage devices such as the inverter device so that the occupants can be protected safely from high-voltage electricity at the time of vehicle collision. In addition, it is desirable to arrange the battery so as to be less damaged in the case of a side collision of the vehicle.

### RELATED ART DOCUMENTS

### Patent Documents

[Patent Document 1] Japanese Patent Application Publication No. 2001-354039

[Patent Document 2] Japanese Patent Application Publication No. 2011-57191

### DISCLOSURE OF THE INVENTION

### Problems to be Solved by the Invention

The present invention was made in view of above-mentioned point, and the purpose is to provide the mounting structure for the high-voltage control equipment unit that allows placement of the battery and the high-voltage electric equipment under an appropriate temperature environment and minimization of an impact at the time of vehicle collision, in addition to effective use of the space in the vehicle compartment, by devising arrangement configuration of the high-voltage control equipment unit including the battery for driving the vehicle and incidental high-voltage electrical components.

### Means of Solving the Problems

To solve the above-described problem, the present invention provides a mounting structure for a high-voltage control equipment unit having a battery for driving a vehicle mounted above a floor panel of the vehicle. The high-voltage control equipment unit (20) is a unit including at least two batteries (50-1, 50-2) for driving the vehicle juxtaposed in the width direction of the vehicle (1), a high-voltage electrical component (56) for controlling power delivery from the batteries (50-1, 50-2), and a case (30) housing the batteries (50-1, 50-2) and the high-voltage electrical component (56). The two batteries (50-1, 50-2) are mounted under a plurality of front seats (5-1, 5-2) juxtaposed in the width direction of the vehicle (1). The high-voltage electrical component (56) is mounted at a position sandwiched between the two batteries (50-1, 50-2) in the width direction of the vehicle (1). On a bottom surface (33) of the case (30), a recessed portion (32) in which a vehicular component (4) extending in the longitudinal direction of the vehicle (1) at least at a position corresponding to the case is arranged is formed.

According to the mounting structure for the high-voltage control equipment unit of the present invention, on the bottom surface of the case, the recessed portion in which a vehicular component extending in the longitudinal direction of the vehicle at least at a position corresponding to the case is arranged is formed. Thus, the high-voltage control equipment unit mounted above the vehicular component can be positioned at a low height. This necessitates no part of the high-voltage control equipment unit to be projected into the vehicle compartment, thereby enabling effective use of the space in the compartment. Even if the whole of the high-voltage control equipment unit is arranged under the seat in the compartment, the seat is not located at a high position. This can achieve a lowered floor of the vehicle (lowered floor surface in the vehicle compartment). The vehicular component here may be a driving force transmitting member for transmitting a driving force of the vehicle. The vehicular component may also be an exhaust pipe in which exhaust from the engine as a drive source of the vehicle circulates. The vehicular component may also be auxiliary machinery mounted on the vehicle or a wiring component for supplying power to this auxiliary machinery.

Furthermore, in the mounting structure in accordance with the present invention, as the installment of the above-mentioned recessed portion allows the high-voltage control equipment unit mounted above the vehicular component to be positioned at a low height, the high-voltage control equipment unit including the battery for driving the vehicle can be mounted under the front seat having a relatively low temperature. This achieve optimization of the temperature environment of the battery.

Moreover, according to the mounting structure for the high-voltage control equipment unit of the present invention, at least the two batteries are juxtaposed in the vehicle width direction under the front seats, and the high-voltage electrical component is arranged at the position sandwiched between these two batteries. Accordingly, the high-voltage electrical component is arranged at the center in the vehicle width direction and farthest from both sides of the vehicle, or in the vicinity thereof. This can suppress an impact on the high-voltage electrical component at the time of side collision of the vehicle. Also, the arrangement of the batteries and the high-voltage electrical component under the front seats can suppress an impact on the batteries and the high-voltage electrical component at the time of vehicle collision. Thus, malfunction or mechanical failure due to an impact of side collision of the vehicle can be prevented from occurring to the high-voltage electrical component, and the high-voltage control equipment unit having the batteries can avoid any troubles.

Furthermore, in the above-mentioned mounting structure, the two batteries (50-1, 50-2) are arranged respectively on both sides of the recessed portion (32) in the vehicle width direction, and the high-voltage electrical component (56) may be housed right above the recessed portion (32).

According to this configuration, even if the recessed portion for arranging the driving force transmitting member therein is formed on the bottom surface of the case, the components of the high-voltage control equipment unit can be efficiently housed in the case, keeping the thickness (height) thereof small.

Furthermore, in the above-mentioned mounting structure, a pair of reinforcing members (26, 27) arranged in the vehicle width direction at a predetermined interval and extending in the longitudinal direction is installed above the floor panel (9). The high-voltage control equipment unit (20) may be arranged so that both sides thereof in the vehicle width direction are sandwiched by the pair of reinforcing members (26, 27).

According to this configuration, as the reinforcing members are arranged on both sides of the high-voltage control equipment unit in the vehicle width direction, the high-voltage control equipment unit is protected from an impact from all sides. This can effectively prevent the high-voltage control equipment unit from crushing because of an impact at the time of vehicle collision.

Moreover, the above-mentioned mounting structure may include a plurality of seat rails (18, 19) supporting the front seats (5-1, 5-2) so as to be slidable independently above the floor panel (9) in the longitudinal direction of the vehicle (1), and the high-voltage control equipment unit (20) may be arranged at a position lower than the seat rails (18, 19).

At the time of side collision of the vehicle, an excessive collision load is applied to the front seat arranged at a position outside the high-voltage control equipment unit in the vehicle width direction. This might cause deformation and falling of the front seat. Even in such cases, as described above, the arrangement of the high-voltage control equipment unit at a position lower than the seat rail can reduce chances of impact of deformation and falling of the front seat on the high-voltage control equipment unit.

Moreover, the present invention is the mounting structure for the high-voltage control equipment unit having the batteries for driving the vehicle mounted above the floor panel of the vehicle. The high-voltage control equipment unit (20) includes at least the two batteries (50-1, 50-2) for driving the vehicle juxtaposed in the width direction of the vehicle (1) and the high-voltage electrical component (56) for controlling power delivery from the batteries (50-1, 50-2). The two batteries (50-1, 50-2) are mounted under the plurality of front seats (5-1, 5-2) juxtaposed in the width direction of the vehicle (1). The mounting structure includes the seat rails (18, 19) supporting the plurality of seats (5-1, 5-2) so as to be slidable independently above the floor panel (9) in the longitudinal direction of the vehicle (1). The high-voltage control equipment unit (20) is arranged at a position lower than the seat trails (18, 19).

According to the mounting structure for the high-voltage control equipment of the present invention, the arrangement of the high-voltage control equipment unit at a position lower than the seat rails necessitates no part of the high-voltage control equipment unit to be projected into the vehicle compartment, thereby enabling effective use of the space in the compartment.

In addition, according to the mounting structure for the high-voltage control equipment unit of the present invention, the arrangement of the high-voltage control equipment unit at a position lower than the seat rails can suppress an impact on the high-voltage control equipment unit at the time of side collision of the vehicle. In particular, an excessive collision load is applied to the front seats arranged at a position outside the high-voltage control equipment unit in the vehicle width direction at the time of side collision of the vehicle, whereby deformation and falling might occur to the front seats. Even in such cases, as described above, the arrangement of the high-voltage control equipment unit at a position lower than the seat rail can reduce chances of impact of deformation and falling of the front seat on the high-voltage control equipment unit. Thus, malfunction or mechanical failure due to an impact of side collision of the vehicle can be prevented from occurring to the high-voltage control equipment unit, and the high-voltage control equipment unit having the batteries can avoid any troubles.

Furthermore, in the above-described mounting structure, the high-voltage electrical component (56) may be mounted between the plurality of front seats (5-1, 5-2) in the vehicle width direction.

According to this configuration, the high-voltage electrical component is arranged at the center in the vehicle width direction and farthest from both sides of the vehicle, or in the vicinity thereof. This can suppress an impact on the high-voltage electrical component at the time of side collision of the vehicle. Thus, malfunction or mechanical failure due to an impact of side collision of the vehicle can be prevented from occurring to the high-voltage electrical component, and the high-voltage control equipment unit having the batteries can avoid any troubles.

Furthermore, in the above-mentioned mounting structure, the pair of reinforcing members (26, 27) arranged in the vehicle width direction of the vehicle 1 at a predetermined interval and extending in the longitudinal direction is installed above the floor panel (9). The high-voltage control equipment unit (20) may be arranged so that both sides thereof in the vehicle width direction are sandwiched by the pair of reinforcing members (26, 27).

According to this configuration, as the reinforcing members are arranged on both sides of the high-voltage control equipment unit in the vehicle width direction, the high-voltage control equipment unit is protected from an impact from all sides. This can effectively prevent the high-voltage control equipment unit from crushing because of an impact at the time of vehicle collision.

Furthermore, in the above-described mounting structure, the high-voltage control equipment unit (20) may include the case (30) integrally housing the batteries (50-1, 50-2) and the high-voltage electrical component (56). This configuration enables effective protection of the batteries for driving the vehicle and the high-voltage electrical component from an impact from all sides.

It is to be noted that the above symbols in parentheses each represent a symbol denoting the corresponding component in embodiments described later, as an example of the present invention.

### Effects of the Invention

The mounting structure for the high-voltage control equipment unit in accordance with the present invention enables minimization of an impact at the time of vehicle collision, in addition to effective use of the space in the vehicle compartment.

### BRIEF DESCRIPTION OF THE DRAWINGS

FIG. 1 is a schematic diagram illustrating a hybrid electric vehicle (HEV) provided with a high-voltage control equipment unit according to a first embodiment of the present invention;

FIG. 2 is a perspective view of a high-voltage control equipment unit;

FIG. 3 is a disassembled perspective view of an outline illustrating components of a high-voltage control equipment unit;

FIG. 4 is a plane view of an outline illustrating a configuration of a high-voltage control equipment unit with respect to a driver's seat and a passenger's seat;

FIG. 5 is a sectional side elevation of a high-voltage control equipment unit viewed from the rear side of a vehicle;

FIG. 6 is a schematic diagram illustrating a hybrid electric vehicle (HEV) provided with a high-voltage control equipment unit according to a second embodiment of the present invention; and

FIG. 7 is a sectional side elevation of a high-voltage control equipment unit of a second embodiment viewed from the rear side of a vehicle.

### MODE FOR CARRYING OUT THE INVENTION

Embodiments of the present invention will be described in detail as below with reference to the accompanying drawings. It should be noted that in the following description, any expressions representing directions such as above (high, upward), under (low, downward), front and rear (longitudinal, forth and back, before and behind), and left and right (lateral, width) are those of a vehicle 1 that will be described below. In addition, Arrow FR in a figure shows the front side direction (forward direction) of the vehicle 1. In addition, “lateral (left and right) direction” and “(vehicle) width direction” in the following description refer to the width direction with respect to the travel direction (longitudinal direction) of the vehicle.

### First Embodiment

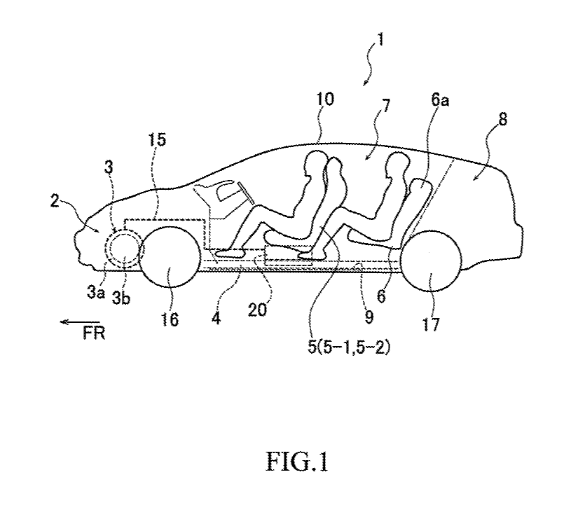

FIG. 1 is a schematic diagram illustrating a hybrid electric vehicle (HEV) provided with a high-voltage control equipment unit according to a first embodiment of the present invention. The vehicle 1 shown in the figure includes a body 10 made of seat metal. And in an engine room 2 arranged in the front of the body 10, a power unit 3 consisting of an engine 3a and a motor generator 3b installed in series is mounted. The motor generator 3b is, for example, a three-phase AC motor. The vehicle 1 is a hybrid electric vehicle (HEV) that assists with driving of the engine 3a, which is an internal combustion engine, using the motor generator 3b and can collect power from the motor generator 3b when the vehicle decelerates.

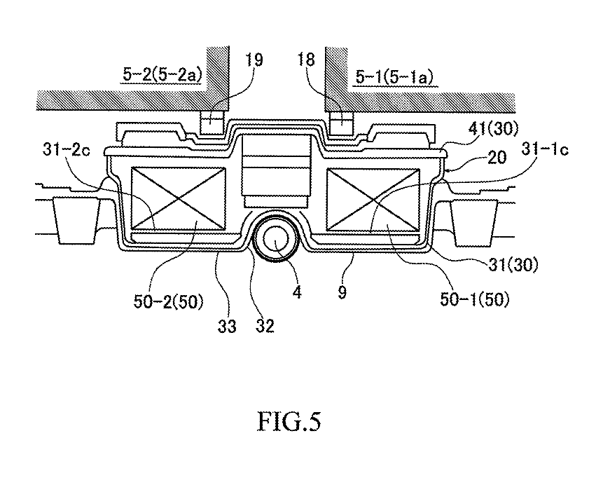

Moreover, the vehicle 1 of this embodiment is a four-wheel drive (4WD) vehicle in which a driving force from the power unit 3 is transmitted to a front wheel 16 and a rear wheel 17. Accordingly, the vehicle 1 includes a propeller shaft (vehicular component, driving force transmitting member) 4 for transmitting a driving force from the power unit 3 to a rear differential (not shown in the figure) from a front differential (not shown in the figure). The propeller shaft 4 extends in the longitudinal direction from a position corresponding to the front wheel 16 to a position corresponding to the rear wheel 17 at the center in the width direction under a floor panel 9 of the vehicle 1 (see FIG. 5).

In the vehicle 1, a driving force from the engine 3a and the motor generator 3b is transmitted to the front wheel 16 as a main driving wheel and the rear wheel 17 as an auxiliary driving wheel. In addition, when a driving force is transmitted to the motor generator 3b from the front wheel 16 or the rear wheel 17 when the vehicle 1 decelerates, the motor generator 3b functions as a generator to generate so-called a regenerative braking force, whereby kinetic energy of the vehicle 1 is collected as electric energy. With the collected electric energy, a battery of a battery module 50 is charged via an electric power converter such as an inverter device included in a high-voltage device 56 that will be described below.

A vehicle compartment 7 in which a front seat 5 and a rear seat 6 are arranged is provided behind the engine room 2. In addition, a trunk 8 partitioned off via the vehicle compartment 7 and a seat back 6a of the rear seat 6 is provided behind the compartment 7 (above the rear wheel 17).

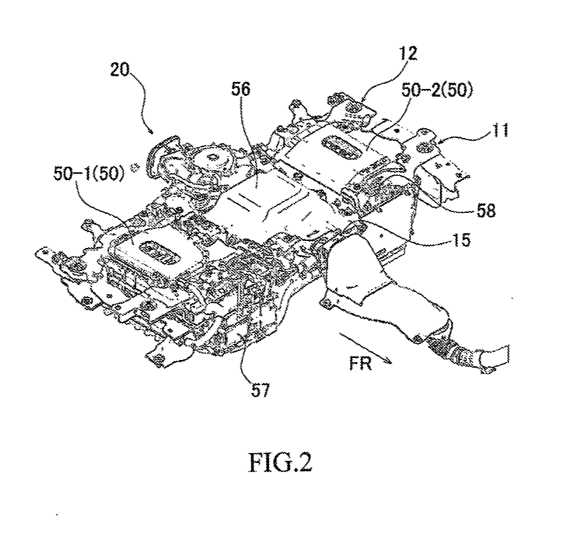

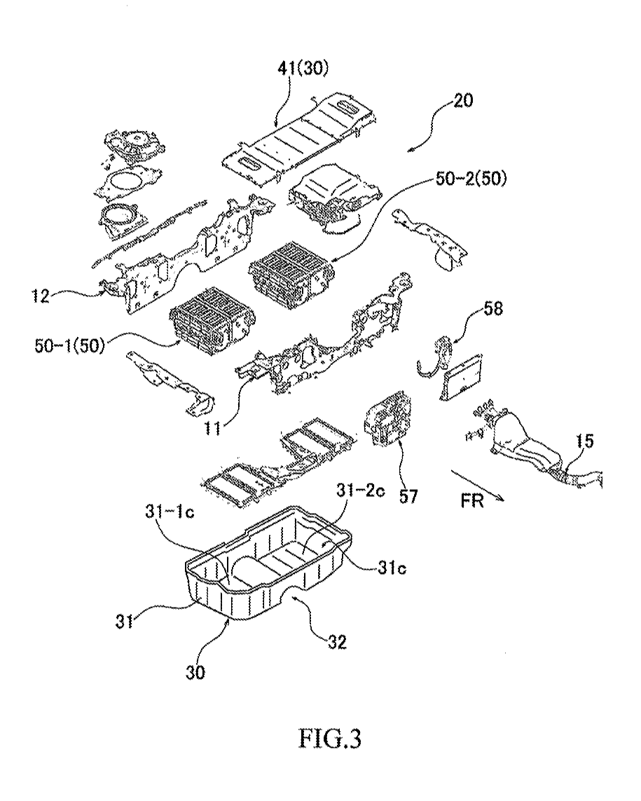

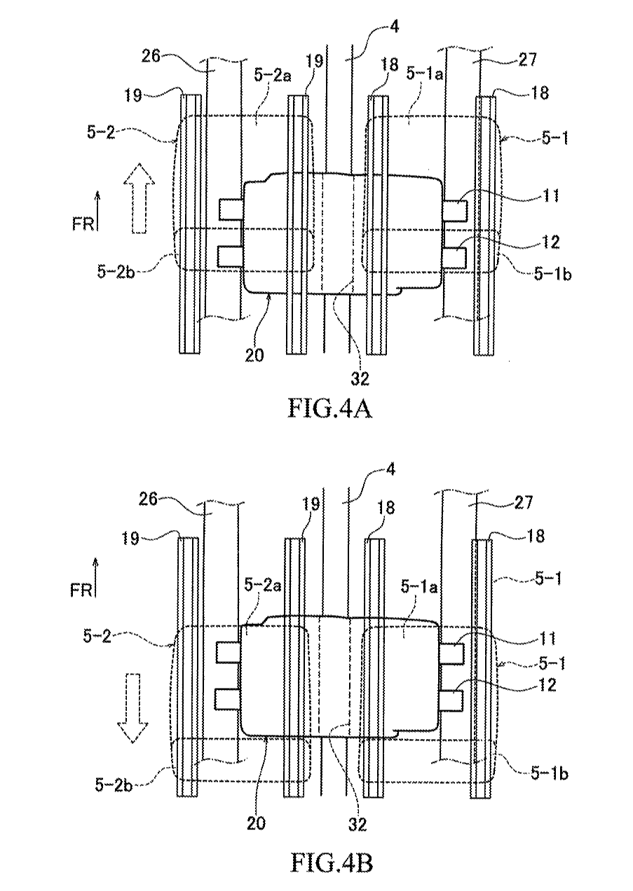

A high-voltage control equipment unit 20 connected to the power unit 3 via an electrical power cable 15 is arranged under the front seat 5 (driver's seat 5-1 and passenger's seat 5-2) in the vehicle compartment 7. FIG. 2 is a perspective view of the high-voltage control equipment unit 20. FIG. 3 is a disassembled perspective view of an outline illustrating components of the high-voltage control equipment unit 20. FIG. 4 is a plane view of an outline illustrating a configuration of the high-voltage control equipment unit 20 with respect to the driver's seat 5-1 and the passenger's seat 5-2, and FIG. 5 is a sectional side elevation of the high-voltage control equipment unit 20 viewed from the rear side of the vehicle 1. In each figure, components inside the high-voltage control equipment unit 20 (such as the battery module 50, the high-voltage device 56, a power distribution component 57 and a main switch 58) are shown in a simplified manner.

As shown in FIG. 4, a pair of side frames (reinforcing members) 26, 27 extending in the longitudinal direction of the vehicle 1 is installed above the floor panel 9 in the vehicle compartment 7. The side frames 26, 27 are long-length members bend-formed so that the cross section thereof is convex upward, linearly extending in the longitudinal direction of the vehicle 1 at both sides of the high-voltage control equipment unit 20. The floor panel 9 and the side frames 26, 27 are members forming part of the body 10.

Further, in the case 30, which will be described below, of the high-voltage control equipment unit 20, a pair of cross members (another pair of reinforcing members) 11, 12 extending in the width direction of the vehicle 1 is installed. The cross members 11, 12 are run between the pair of side frames 26, 27 on the both sides and juxtaposed at an interval in the longitudinal direction.

As shown in FIGS. 1 and 4, the driver's seat 5-1 and the passenger's seat 5-2 are installed above the floor panel 9. Each of the driver's seat 5-1 and the passenger's seat 5-2 is provided with a seating part 5-1a, 5-2a and a backrest 5-1b, 5-2b and attached to the seat rail 18, 19 extending in the longitudinal direction above the floor panel 9 so as to be supported slidably in the longitudinal direction. FIG. 4A and FIG. 4B are views illustrating the driver's seat 5-1 and the passenger's seat 5-2, which slide forth and back along the seat rails 18, 19, being respectively at the forefront and rearmost positions.

In this embodiment, the high-voltage control equipment unit 20 is mounted between the floor panel 9 and the driver's and passenger's seats 5-1, 5-2. The high-voltage control equipment unit 20 is a unit including the battery module 50, the high-voltage electrical component 56 and the power distribution component 57 for controlling power delivery from the battery module 50, the main switch 58 for the battery module 50, and the case 30 housing these components. The whole of this high-voltage control equipment unit 20 in the lateral direction is installed under the driver's seat 5-1 and the passenger's seat 5-2.

As shown in FIG. 2, the high-voltage control equipment unit 20 is provided with the battery case 30 consisting of a lower cover 31 and an upper cover 41. In this battery case 30, the battery module 50, the high-voltage electrical component 56, the power distribution component (high-voltage electrical component) 57 and the main switch (starter) 58 for the battery module 50 are housed. The battery case 30 is a container, for instance, made of steel. On one hand, the lower case 31 is a bottomed container having an opening 32 facing upward of the vehicle 1 and serving as a housing 31c for housing the battery module 50 and other components. On the other hand, the upper cover (lid) 41 is an approximately plate-like member covering the opening 32 of the lower case 31.

On the center of a bottom surface 33 of the case 30 in the vehicle width direction, a belt-shaped recessed portion 21 is provided so as to be recessed upward and penetrate the case 30 in the longitudinal direction. As shown in FIG. 5, the recessed portion 21 is formed so that the sectional configuration thereof viewed from the longitudinal direction is approximately inverted U-shaped. The recessed portion 21 is arranged between the driver's seat 5-1 and the passenger's seat 5-2 in the vehicle width direction and extends in the longitudinal direction of the vehicle 1. In this recessed portion 21, a propeller shaft 4 extending in the longitudinal direction of the vehicle 1 is arranged (housed). This recessed portion 21 allows the high-voltage control equipment unit 20 (case 30) to be mounted so as to avoid the propeller shaft 4 thereabove.

The battery module 50 in the housing 31c includes the two batteries 50-1, 50-2 juxtaposed in the vehicle width direction, and both batteries have an approximately rectangular parallelepiped outer shape along the inner shape of the housing 31c. The two batteries are housed respectively in the housings 31-1c, 31-2c recessed downward on both sides of the recessed portion 32 inside the lower case 31, and installed so as to be divided respectively into the left and right sides of the recessed portion 32. And, the high-voltage device 56 is housed right above the recessed portion 32 in the lower case 31. Therefore, the high-voltage device 56 is mounted between the driver's seat 5-1 and the passenger's seat 5-2 in the vehicle width direction. In addition, the high-voltage device 56 is mounted at a position sandwiched between the two batteries 50-1, 50-2.

Moreover, the front and rear cross members 11, 12 are installed respectively before and behind the high-voltage device 56 and respectively before and behind the two batteries 50-1, 50-2. Both ends of the front and rear cross members 11, 12 are connected respectively to the side frames 18, 19. Thus, the high-voltage devices 56 and the two batteries 50-1, 50-2 are installed so that side surfaces thereof are surrounded by the front and rear cross members 11, 12 and the left and right side frames 18, 19. In addition, the power distribution component 57 and the main switch 58 are arranged at a position adjacent to the front side of the cross-members 11, 12.

The batteries 50-1, 50-2 are arranged in the way that a multiplicity of battery cells are bundled together integrally, although not illustrated in detail. The high-voltage device 56 is an electronic device including an inverter device having an inverter and a converter device having a DC/DC converter. To the high-voltage device 56, also electronic equipment such as an ECU is provided, although not illustrated in detail. The high-voltage device 56 functions so as to obtain a direct current from the battery module 50, convert this direct current into a three-phase AC current, supply this current to the motor generator 3b, drive this motor generator 3b, and convert a regeneration current from the motor generator 3b into a direct current, thereby enabling charging of the battery module 50.

The power distribution component 57 is a component integrally including a multiplicity of wires connected to the battery module 50 and the high-voltage device 56 and a large number of connectors for connecting these wires. This power distribution component 57 has such a complex structure that the multiplicity of wires branches via the connectors. The main switch 58 is a switch, connected to the battery cells included by each of the batteries 50-1, 50-2, for changing ON/OFF of energization of the battery module 50.

The high-voltage control equipment unit 20 of this embodiment is a unit including the two batteries 50-1, 50-2 for driving the vehicle juxtaposed in the width direction of the vehicle 1, the high-voltage device (high-voltage electrical component) 56 for controlling power delivery from the batteries 50-1, 50-2, and the case 30 integrally housing the batteries 50-1, 50-2 and the high-voltage device 56. The two batteries 50-1, 50-2 are mounted under the left and right front seats 5-1, 5-2 juxtaposed in the vehicle width direction of the vehicle 1. The high-voltage device 56 is mounted at a position sandwiched between the two batteries 50-1, 50-2 in the width direction of the vehicle 1. On the bottom surface 33 of the case 30, the recessed portion 32 in which the propeller shaft (driving force transmission member) 4 extending in the longitudinal direction of the vehicle 1 at least at the position corresponding to the case 30 is arranged.

According to the mounting structure for the high-voltage control equipment unit 20 of this embodiment, the recessed portion 32 in which the propeller shaft 4 extending in the longitudinal direction of the vehicle 1 is housed is formed on the bottom surface 33 of the case 30. This allows the high-voltage control equipment unit 20 mounted above the propeller shaft 9 to be positioned at a low height. Accordingly, there is no need to install any part of the high-voltage control equipment unit 20 to be projected into the vehicle compartment 7. This enables effective use of space in the vehicle compartment 7. Even if the whole of the high-voltage control equipment unit 20 is arranged under the seat 5 in the compartment 7, the seat 5 is not located at a high position. This can achieve a lowered floor of the vehicle 1 (lowered floor surface in the vehicle compartment 7).

Furthermore, according to the mounting structure for the high-voltage control equipment unit 20 of this embodiment, since the two batteries 50-1, 50-2 juxtaposed in the vehicle width direction are mounted under the front seats 5-1, 5-2, and the high-voltage device 56 is arranged at a position sandwiched between those two batteries 50-1, 50-2, the high-voltage electrical device 57 is arranged at the center in the vehicle width direction and farthest from both sides of the vehicle 1, or in the vicinity thereof. This can suppress an impact on the high-voltage device 57 at the time of side collision of the vehicle. Moreover, the arrangement of the batteries 50-1, 50-2 and the high-voltage device 57 under the front seat 5 suppresses an impact on the batteries 50-1, 50-2 and the high-voltage electrical component 57 at the time of collision of the vehicle 1. Thus, malfunction or mechanical failure due to an impact of side collision of the vehicle 1 can be prevented from occurring to the high-voltage device 57, and the high-voltage control equipment unit 20 having the batteries 50-1, 50-2 can avoid any troubles.

Moreover, in the mounting structure for the high-voltage control equipment unit 20 of the present embodiment, the two batteries 50-1, 50-2 are installed so as to be divided respectively into both sides of the recessed portion 32 in the vehicle width direction, and the high-voltage electrical component 56 is arranged right above the recessed portion 32 and mounted at a position sandwiched between the two batteries 50-1, 50-2. According to this configuration, even if the recessed portion 4 for arranging the propeller shaft 4 therein is formed on the bottom surface 33 of the case 30, the components of the high-voltage control equipment unit 20 can be efficiently housed in the case 30, keeping the thickness (height) thereof small.

Furthermore, in the mounting structure for the high-voltage control equipment unit 20 of the present embodiment, the pair of side frames (reinforcing members) 26, 27 arranged at a predetermined interval in the width direction of the vehicle 1 and extending in the longitudinal direction is installed above the floor panel 9. The high-voltage control equipment unit 20 is arranged so that both sides thereof in the vehicle width direction are sandwiched by the pair of side frames 26, 27. This configuration enables protection of the high-voltage control equipment unit 20 from an impact from all sides. This can effectively prevent the high-voltage control equipment unit 20 from crushing due to an impact at the time of collision of the vehicle 1.

Moreover, since the mounting structure of the present embodiment includes the cross members 11, 12 run between the pair of side frames 26, 27 and extending in the width direction of the vehicle 1, the high-voltage control equipment unit 20 (especially, the batteries 50-1, 50-2 and the high-voltage device 56) is surrounded on all four sides in the longitudinal and width directions by the pair of side frames 26, 27 and the pair of the cross members 11, 12 and accordingly protected from an impact from all sides. This can effectively prevent the high-voltage control equipment unit from crushing because of an impact at the time of vehicle collision.

Moreover, the mounting structure of the present embodiment includes the seat rails 18, 19 supporting the left and front seats 5-1, 5-2 so as to be slidable independently above the floor panel 9 in the longitudinal direction of the vehicle 1, and the whole of the high-voltage control equipment unit 20 is arranged at a position lower than the seat rails 18, 19. In particular, at the time of side collision of the vehicle 1, an excessive collision load is applied to the front seat 5 arranged at a position outside the high-voltage control equipment unit 20 in the vehicle width direction at the time of side collision of the vehicle 1, whereby deformation and falling might occur to the front seat 5. Even in such cases, as described above, the arrangement of the whole of the high-voltage control equipment unit 20 at a position lower than the seat rails 18, 19 can reduce chances of impact of deformation and falling of the front seat 5 on the high-voltage control equipment unit 20.

Furthermore, the high-voltage control equipment unit 20 of the present embodiment is a unit having the batteries 50-1, 50-2 for driving the vehicle 1 mounted above the floor panel 9 of the vehicle 1, and including the two batteries 50-1, 50-2 for driving the vehicle 1 juxtaposed in the width direction of the vehicle 1 and the high-voltage device 56 for controlling power delivery from the batteries 50-1, 50-2, and the case 30 integrally housing the batteries 50-1, 50-2, the high-voltage device 56 and the starter 58. The two batteries 50-1, 50-2 are mounted under the left and right front seats 5-1, 5-2 juxtaposed in the width direction of the vehicle 1. The mounting structure of the present embodiment includes the seat rails 18, 19 supporting the left and front seats 5-1, 5-2 so as to be slidable independently above the floor panel 9 in the longitudinal direction of the vehicle 1. The high-voltage control equipment unit 20 is arranged at a position lower than the seat rails 18, 19.

According to this configuration, the arrangement of the high-voltage control equipment unit 20 at a position lower than the seat rails 18, 19 can suppress an impact on the high-voltage control equipment unit 20 at the time of side collision of the vehicle 1. In particular, at the time of side collision of the vehicle 1, an excessive collision load is applied to the front seat 5 arranged at a position outside the high-voltage control equipment unit 20 in the vehicle width direction, whereby deformation and falling might occur to the front seat. Even in such cases, as described above, the arrangement of the high-voltage control equipment unit 20 at a position lower than the seat rails 18, 19 can reduce chances of impact of deformation and falling of the front seat 5 on the high-voltage control equipment unit 20. Thus, malfunction or mechanical failure due to an impact of side collision of the vehicle 1 can be prevented from occurring to the high-voltage equipment unit 20, and the high-voltage control equipment unit 20 having the batteries 50-1, 50-2 can avoid any troubles.

### Second Embodiment

Next, a second embodiment of the invention will be described below. In the description of the second embodiment and the corresponding figures, like reference characters refer to components corresponding or equivalent to those of the first embodiment, and a detailed description thereof is dispensed with.

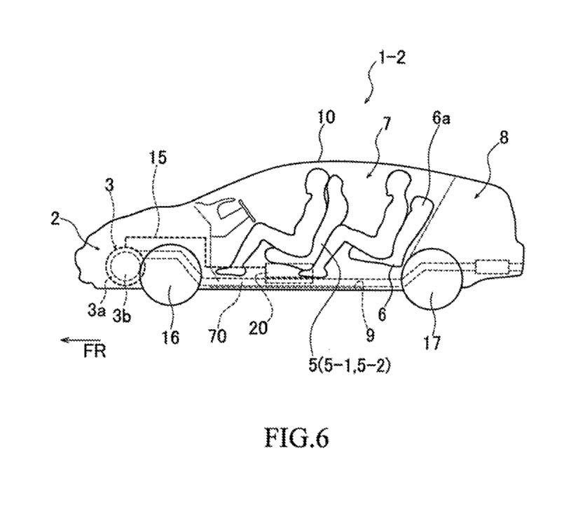

FIG. 6 is a schematic diagram illustrating a hybrid electric vehicle (HEV) 1-2 provided with the high-voltage control equipment unit 20 according to the second embodiment of the present invention. While the vehicle 1 of the first embodiment is a four-wheel drive (4WD) vehicle in which a driving force from the power unit 3 is transmitted to the front wheel 16 and the rear wheel 17, the vehicle 1-2 of the second embodiment is a front-wheel drive (two-wheel drive or 2WD) vehicle in which a driving force from the power unit 3 is transmitted only to the front wheel 16. Accordingly, the vehicle 1-2 of the second embodiment is provided with no propeller shaft (vehicular component, driving force transmission member) 4.

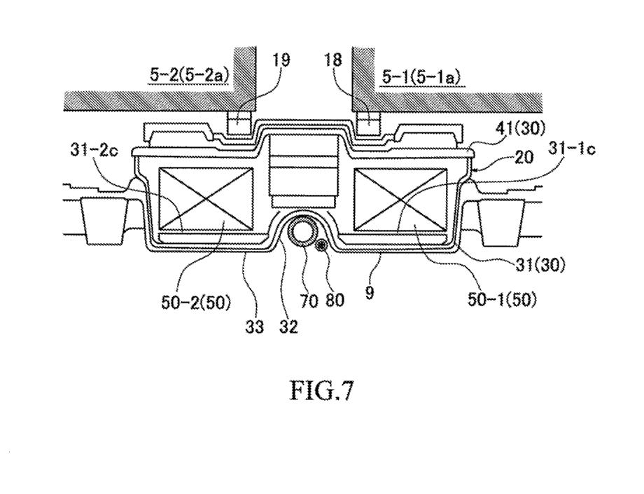

FIG. 7 is a sectional side elevation of the high-voltage control equipment unit 20 of the second embodiment viewed from the rear side of the vehicle. The vehicle 1-2 of the present embodiment includes an exhaust pipe (vehicular component) 70 for guiding exhaust air from the engine 3a to the rear of the vehicle 1. At the center in the width direction under the floor panel 9, the exhaust pipe 70 extends in the longitudinal direction from the engine 3a towards the rear end of the vehicle 1-2. And, as shown in FIG. 7, the exhaust pipe 70 is arranged in the recessed portion 32 provided on the bottom surface 33 of the case 30. In other words, on the bottom surface 33 of the case 30 included by the high-voltage control equipment unit 20 of the present embodiment, the recessed portion 32 is formed for arranging therein the exhaust pipe 70 in which the exhaust air from the engine 3a circulates.

In addition, as shown in FIG. 7, in the present embodiment, the wires (wiring components) 80 is arranged in the recessed portion 32 for supplying electric power to auxiliary machinery (not shown in the figure) mounted on the vehicle 1-2.

At least part of the wires 80 corresponding to the case 30 extends in the longitudinal direction of the vehicle 1-2, and this part is arranged in the recessed portion 32. The auxiliary machinery here mentioned includes, for example, various electric lights and air-conditioners and related parts thereof mounted on the vehicle 1-2. It should be noted that the wires 80 is not shown in FIG. 6.

In the present embodiment also, the recessed portion 32 in which the exhaust pipe 70 or the wires 80 extending at least at the position corresponding to the case 30 in the longitudinal direction of the vehicle 1 are housed is formed on the bottom surface 33 of the case 30. This allows the high-voltage control equipment unit 20 mounted above the exhaust pipe 70 or the wires 80 to be positioned at a low height. Accordingly, there is no need to install any part of the high-voltage control equipment unit 20 to be projected into the vehicle compartment 7, thereby enabling effective use of the space in the compartment. In addition, even if the whole of the high-voltage control equipment unit 20 is arranged under the seat 5 in the compartment 7, the seat 5 is not located at a high position. This can achieve a lowered floor of the vehicle 1 (lowered floor surface in the vehicle compartment 7).

In the foregoing, the embodiments of the present invention have been described. However, the present invention is not limited to the above embodiments, but various modifications of the present invention are possible within the scope of the technical idea described in the claims, specification, and drawings. While in the above-described embodiments, the hybrid electric vehicle (HEV) 1 is illustrated as a vehicle provided with the high-voltage control equipment unit 20 according to the present invention, the present invention can be applied to other kinds of vehicles such as an electric vehicle, as far as the vehicles are provided with a high-voltage control equipment unit including batteries for driving the vehicles, a high-voltage electrical component for controlling power delivery from the batteries and a starter of the batteries, but not limited to the hybrid electric vehicle (HEV) 1 as described above.

Moreover, the propeller shaft 4 (driving force transmitting member), the exhaust pipe 70 and the wires 80 are described in the above-described embodiments as the vehicular components arranged in the recessed portion 32 provided on the bottom surface 33 of the case 30, other components may be arranged in the recessed portion 32 provided on the bottom surface 33 of the case 30. For instance, not only the wires (wiring component) 80 for supplying electric power to the auxiliary machinery, but also the auxiliary machinery or other related accessories may be arranged in the recessed portion 32 provided on the bottom surface 33 of the case 30, although not illustrated in the figure. Furthermore, when the power cable (high-tension wire, three-phase line) 15 pulled out from the power unit 3 is connected to apparatuses other than the high-voltage control equipment unit 20, this power cable 15 may be configured to be guided toward behind the high-voltage control equipment unit 20 (rear side of the vehicle) by arranging this power cable 15 in the recessed portion 32 provided on the bottom surface 33 of the case 30, although not illustrated in the figure.

Furthermore, while in the above-described embodiments, the recessed portion 32 provided on the bottom surface 33 of the case 30 is arranged on the center of the bottom surface 33 of the case 3 in the vehicle width direction, where to arrange the recessed portion 32 is not restricted thereto but may be another position as far as on the bottom surface 33 of the case 30. For instance, the recessed portion 32 may be arranged at a position biased laterally in the vehicle width direction.

1. A mounting structure for a high-voltage control equipment unit having a battery for driving a vehicle, the high-voltage equipment unit mounted above a floor panel of the vehicle,
wherein the high-voltage control equipment unit is a unit including at least two batteries for driving the vehicle, the two batteries juxtaposed in a width direction of the vehicle, a high-voltage electrical component for controlling power delivery from the batteries and a case integrally housing the batteries and the high-voltage electrical component,
wherein the two batteries are mounted under a plurality of front seats juxtaposed in the width direction of the vehicle,
wherein the high-voltage electrical component is mounted at a position between the two batteries in the width direction of the vehicle, and
wherein a recessed portion in which a vehicular component extending in the longitudinal direction of the vehicle at least at a position corresponding to the case is arranged is formed on a bottom surface of the case.

2. The mounting structure for the high-voltage control equipment unit according to claim 1, wherein the vehicular component is a driving force transmitting member for transmitting a driving force of the vehicle.

3. The mounting structure for the high-voltage control equipment unit according to claim 1, wherein the vehicular component is an exhaust pipe in which exhaust from an engine as a drive source of the vehicle circulates.

4. The mounting structure for the high-voltage control equipment unit according to claim 1, wherein the vehicular component is auxiliary machinery mounted on the vehicle or a wiring component for supplying electric power to the auxiliary machinery.

5. The mounting structure for the high-voltage control equipment unit according to claim 1,
wherein the two batteries are arranged respectively on both sides of the recessed portion in the vehicle width direction, and
wherein the high-voltage electrical component is housed at a position right above the recessed portion.

6. The mounting structure for the high-voltage control equipment unit according to claim 1,
wherein a pair of reinforcing members arranged in the width direction of the vehicle at a predetermined interval and extending in the longitudinal direction is installed above the floor panel, and
wherein the high-voltage control equipment unit is arranged so that both sides thereof in the vehicle width direction are sandwiched by the pair of reinforcing members.

7. The mounting structure for the high-voltage control equipment unit according to claim 1, the mounting structure comprising a plurality of seat rails supporting the plurality of front seats so as to be slidable independently above the floor panel in the longitudinal direction of the vehicle,
wherein the high-voltage control equipment unit is arranged at a position lower than the seat rails.

8. A mounting structure for a high-voltage control equipment unit having batteries for driving a vehicle mounted above a floor panel of the vehicle,
wherein the high-voltage control equipment unit is a unit including at least two batteries for driving the vehicle, the two batteries juxtaposed in a width direction of the vehicle and a high-voltage electrical component for controlling power delivery from the batteries,
wherein the two batteries are mounted under a plurality of front seats juxtaposed in the width direction of the vehicle,
wherein the mounting structure comprises seat rails supporting the plurality of front seats so as to be slidable independently above the floor panel in the longitudinal direction of the vehicle, and
wherein the high-voltage control equipment unit is arranged at a position lower than the seat rails.

9. The mounting structure for the high-voltage control equipment unit according to claim 8, wherein the high-voltage electrical component is mounted at a position between the plurality of front seats in the vehicle width direction.

10. The mounting structure for the high-voltage control equipment unit according to claim 8,
wherein a pair of reinforcing members arranged in the width direction of the vehicle at a predetermined interval and extending in the longitudinal direction is installed above the floor panel, and
wherein the high-voltage control equipment unit is arranged so that both sides thereof in the vehicle width direction are arranged at a position sandwiched by the pair of reinforcing members.

11. The mounting structure for the high-voltage control equipment unit according to claim 8, wherein the high-voltage control equipment unit further comprises a case housing the batteries and the high-voltage electrical component.
